(19) United States
(12) Patent Application Publication
(10) Pub. No.: US 2015/0081734 A1
(43) Pub. Date: Mar. 19, 2015

(54) INFORMATION SHARING BETWEEN A HOST AND AN AUDIENCE

(71) Applicant: Jeffrey Scott Mason, Cincinnati, OH (US)

(72) Inventor: Jeffrey Scott Mason, Cincinnati, OH (US)

(21) Appl. No.: 14/462,703

(22) Filed: Aug. 19, 2014

Related U.S. Application Data
(60) Provisional application No. 61/877,525, filed on Sep. 13, 2013.

(51) Int. Cl. G06F 17/30

(52) U.S. Cl. CPC G06F 17/30522; G06F 17/30477
USPC 707/772

(57) ABSTRACT

A system for sharing information from a host to an audience based on a keyword that links the host to the audience includes a processor and a memory coupled with the processor, where the memory includes instructions that when executed by the processor, cause the processor to: (a) obtain host information from a host communications device for an information sharing service, wherein the information sharing service includes an interface for sharing information between the host and the audience; (b) reserve a host keyword associated with the host information; (c) store the host information associated with the host keyword in an information sharing database associated with the information sharing service; (d) receive, by the information sharing service, a keyword matching the host keyword from an audience member communications device via a data network; (e) prompt, by the information sharing service, the audience member communications device to provide audience member contact information; (f) query the information sharing database for the host information when an audience member communications device provides the matching keyword and the audience member contact information to the information sharing service; and (g) provide the host information to the audience member communications device via the information sharing service

### CROSS REFERENCE TO RELATED APPLICATIONS

The current application claims priority to U.S. Provisional Application No. 61/877,525, filed Sep. 13, 2013, the disclosure of which is incorporated herein by reference.

### BACKGROUND

A conference presenter presenting to an audience often would like to share contact information with the audience. The audience has made an effort to observe the presenter, showing an interest in the presenter. The presenter would like to continue to foster the interest of the audience by delivering to the audience a schedule of future presentations along with any other marketing information the presenter would like to deliver to the audience. The presenter may wish to interact with the audience during a presentation; for example, the presenter may wish to provide presentation documents to the audience, conduct polling, ask questions and receive answers in real-time, and provide a platform by which the audience members can communicate and interact amongst themselves.

Traditionally, the presenter verbally communicates the presenter's contact information, such as the presenter's name, e-mail, address, and website, to the audience. The presenter also informs the audience of the social media platforms that the audience may implement to stay informed of updates regarding the presenter. Such verbal communications require unnecessary effort on behalf of the audience to record the presenter's contact information or go to each of the presenter's social media outlets to receive updates on the presenter. As a result, the likelihood that the audience continues to follow the presenter, both during and after a presentation, decreases with any increased effort required by the audience members. The presenter may thus fail to foster the continued interest of the audience.

Similar issues exist in other contexts. In a business meeting where the attendees know each other and work together, there may be a desire for a convenient document repository to which the attendees can virtually connect, thereby saving time, coordination efforts, and paper. A band, performer, or other entertainer may host an audience but still be without a convenient way to connect to the audience on a continued basis. Like a conference presenter, an entertainer may wish to obtain the contact information of concert attendees, to provide such attendees with a single location containing all of the entertainer's social media platforms, to easily sell songs and albums to the attendees, and to allow the attendees to interact amongst themselves. A church organizer may wish to give its congregation book recommendations and daily updates, send and receive prayer requests, distribute music and bulletins, and collect donations more quickly and conveniently. A sports organization may wish to provide fans with in-game features and incentives as well as to cultivate continued fan interest with ongoing updates. Book clubs and other social gatherings may wish for a central hub to provide their members with recommendations and a virtual meeting place. A government may wish to provide its citizens a convenient way, for example, to receive updates regarding changes to transit routes and related schedules. Presently, each one of these scenarios requires considerable effort on behalf of both the information senders and the information receivers. Many more similar situations involving some exchange of information exist.

### SUMMARY

Embodiments of the present disclosure relate to a host sharing information with an audience. Additional embodiments of the present disclosure also relate to one or more audience members giving information to a host. Further embodiments of the present disclosure relate to the mutual exchange of information between one or more audience members and a host. Information may be stored electronically with an information sharing service by the host in advance. Such information may be accessible to each audience member's computing device that provides to the information sharing service a keyword unique to the host information and previously selected by the host. In an embodiment, a system shares information from a host to an audience based on a keyword that links the host to the audience. The system includes a processor and a memory coupled with the processor. The memory includes instructions that, when executed by the processor, cause the processor to obtain the host's information for an information sharing service. The information sharing service may include an interface for sharing information between the host and the audience or individual members of the audience. The processor may be configured to reserve a keyword associated with the host information that is unique to the host information and that may be selected by the host. The processor may also be configured to store the host information based on the keyword in an information sharing database associated with the information sharing service. The processor may further be configured to query the information sharing database for the host information when an audience member provides the keyword to the information sharing service. The processor may be configured to provide the host information to the audience member via the information sharing service. The processor may also be configured to provide audience member information to the host via the information sharing service. The processor may be configured to exchange information between the host and one or more audience members continuously, mutually, and in real-time. In fact, in one embodiment, little or no host information is saved in advance; rather, a connection between a host and an audience member based on a keyword may be made for the purpose of exchanging substantially all information in real-time. As used herein, “real-time” refers to the ability of the host to provide information to the audience members and vice versa with little to no delay. For example, the system or a feature thereof would be considered “real-time” if the users can access updates within about ten seconds or less of the updates being made, or in some cases if the users can access updates within about thirty seconds or less of the updates being made.

In an embodiment, a computer implemented method shares information from a host to an audience via a keyword that links the host to the audience. A processor obtains host information for an information sharing service. The information sharing service may include an interface for sharing information between the host and the audience. A processor reserves a keyword associated with the host information that is unique to the host information and selected by the host. The processor stores the host information associated with the keyword in an information sharing database associated with the information sharing service. The processor queries the information sharing database for the host information when an audience member provides the appropriate keyword to the information sharing service. The processor provides the host information to the audience member via the information sharing service. In similar fashion, audience member information may also be provided to the host via the information sharing service. Host information may be stored in advance, provided as part of a real-time connection, or a combination thereof. Likewise, audience member information may be obtained (1) as a precondition to accessing any host information, (2) as a precondition to accessing only certain sets of host information, (3) as part of a real-time exchange of information between a host and an audience member, or (4) in combinations thereof. For instance, an audience member may be required to provide some basic information, such as contact information, before the information sharing service will share any host information, but the audience member may be required to provide further information, such as feedback or answers to specific questions, before being able to access other host information. In any case, the host may define what audience member information to request and when the information sharing service should request such information.

Another embodiment comprises one or more non-transitory computer readable storage mediums that store a computer program, where the program comprises instructions that, when executed by one or more processors, may cause the one or more processors to perform operations to share information from a host to an audience and vice versa based on a keyword that links the host with the audience. In one embodiment, an information sharing service obtains host information from a host. Information sharing between the host and one or more audience members may be mutual. The information sharing service may provide an interface for sharing information between the host and the audience. The host may reserve a keyword associated with, and unique to, the host information. Alternatively, the information sharing service may suggest to the host a unique keyword to associate with the host information. An information sharing database associated with the information sharing service stores the host information based on the keyword. When an audience member provides the keyword to the information sharing service, the information sharing database is queried for the host information associated with the keyword. The host information is provided to the audience member via the information sharing service. Audience member information may also be provided to the host via the information sharing service. In another embodiment, little or no host information is saved in advance; rather, a connection between a host and an audience member based on a keyword may be made for the purpose of exchanging substantially all information in real-time. Host information may be stored in advance, provided as part of a real-time connection, or a combination thereof. Likewise, audience member information may be obtained (1) as a precondition to accessing any host information, (2) as a precondition to accessing only certain sets of host information, (3) as part of a real-time exchange of information between a host and an audience member, or (4) in combinations thereof. For instance, an audience member may be required to provide some basic information, such as contact information, before the information sharing service will share any host information, but the audience member may be required to provide further information, such as feedback or answers to specific questions, before being able to access other host information. In any case, the host may define what audience member information to request and when the information sharing service should request such information.

Throughout this disclosure, references to “one embodiment,” “an embodiment,” an “exemplary embodiment,” “another embodiment,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it may be within the knowledge of one skilled in the art to effect such feature, structure, or characteristic in connection with other embodiments whether or not explicitly described.

Throughout this disclosure, references to a “host” refer to any person, group of people, or organization wishing to communicate information or content to another person, group of people, or organization. For example, a host could be a meeting organizer, such as one responsible for organizing meetings in a business; a presenter or professional speaker at a seminar or conference; an entertainer, such as a comic, magician, or band; a radio station; a person or group trying to raise funds; a television show or television station; an advertiser, such as a person, group of people, or organization that advertises via television, radio, or billboard; a church leader or religious organization; a sports team or sports organization; a club or camp, or a club or camp organizer; a community organizer, including one who organizes events such as parades, festivals, and fireworks shows; a couple getting married; a business, such as a store or restaurant; a protest movement, a protest organizer, a rally organizer, or persons related to similar movements; a teacher or a school at any educational level; a presenter at a continuing education, training, certification, or other professional learning event; a presenter at a TED talk; a sales presenter or infomercial seller; an academic presenter; a leader of a flash mob; a sports tournament organizer; a career fair or trade show; a host of a museum or art exhibit; or a government or municipal corporation. When the host has an event, the audience generally may be a live, in-person audience. However, in some situations, an event per se may not even be held; a local government may wish to provide an easy way for interested citizens to access important information. Commuting citizens, for instance, might seek a quick and convenient way to check updated transit schedules or to see if a route has road construction. Even a host in a virtual environment, such as an online meeting, may wish to provide attendees with follow up information or features that may not be available on typical virtual meeting applications. These examples are inclusive and are intended to illustrate the breadth and diversity of the possible applications of the present invention.

Throughout this disclosure, references to an “audience” or one or more “audience members” refer to any person or group of people attending an event, meeting, seminar, performance, or other setting where such person or group of people may be capable of receiving information. In particular, such words refer to any person, group of people, or organization capable of or wishing to receive information, especially from a “host” as described above. In some contexts, the word “attendee,” “attendees,” or other appropriate word, depending on the particular context, may be more appropriate in plain English; however, for the sake of simplicity and consistency, the words “audience” and “audience members” will generally be used herein. For example, an audience or audience member may include attendees and audience members being hosted by: a professional speaker; a presenter at a conference; an organizer of a business meeting; an entertainer, such as a band, comic, or magician; a church leader or religious organization; a fund raiser; a camp or club, including youth clubs, book clubs, fraternal organizations, and social organizations; a community group putting on a community event, such as a parade, festival, or fireworks show; a couple about to be married; a retail store or restaurant; an organizer of a rally, protest, or other cause; a teacher or school at any educational level; a presenter at a continuing education, training, certification, or other professional learning event; a presenter at a TED talk; a sales presenter; an academic presenter or lecturer; an organizer of a flash mob; a sports tournament; a career expo or trade show; a museum or art exhibit; or a sports team, organization, or event. Furthermore, an audience or audience member may include a viewer, listener, viewers, and listeners of: advertisements being shown on television, radio, or billboard, television shows, and radio programs. These examples are inclusive and are intended to illustrate the breadth and diversity of the possible applications of the present invention.

Throughout this disclosure, references to “information” or “content” include: documents, notes, handouts, pictures, sound clips, videos, and registration forms, especially electronic versions thereof; a person's or organization's contact information; a question or questions that a host wants to be answered; audience members' answers to a host's question; a poll and polling results; a link to or instructions on how to purchase a product, such as a product sold or promoted by the host; a link or links to one or more social media outlets; embedded social media widgets or functionality; digital versions of a presentation; web-based forums and posts on such forums; donation requests and donations; solicitations for prayer requests and responses; coupons or other incentives; meeting requests, invitations, RSVPS, and confirmations; notifications and updates regarding subject matter related to the host; and other similar information and content that a host might want to share with the audience, depending on the particular case. In some embodiments, information may comprise instructions to set up a future real-time connection between a host and an audience for sharing the other forms of information or content mentioned above. Information may be stored by a host in advance, exchanged between a host and an audience member in real-time, or combinations thereof.

Further embodiments, features, and advantages, as well as the structure and operation of various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 shows an illustration of an information sharing network environment;

FIG. 2 depicts a detailed view of an exemplary information sharing configuration for sharing information between a host and an audience;

FIG. 3 is a flowchart showing an exemplary method for sharing information from a host to an audience based on a keyword that links the host to the audience; and

FIG. 4 illustrates an exemplary computer system in which embodiments of the present disclosure, or portions thereof, may be implemented as computer-readable code.

### DETAILED DESCRIPTION

The disclosure generally relates to information sharing between a host, such as a speaker, entertainer, or other person or organization described above, and an audience, such as an audience as described above. In an exemplary embodiment, a host may request to establish an information exchange between the host and the audience. Such an information exchange would allow the host to provide documents, interact with the audience, and remain in contact with the audience following the event, as well as to enable audience members to interact with each other during an event. The host may enable the information exchange to occur with minimal effort by the audience in order to increase the likelihood that each audience member participates in the information exchange. An information sharing service may act as an interface for the sharing of information between the host and the audience. Such an information sharing service is easily accessible by the communications devices of both the host and the audience. In one embodiment, such an information sharing service is implemented on a website and does not require either the host or any audience member to download any specific application for access. In another embodiment, an audience member and/or the host may download a particular application that implements the information sharing service, eliminating the need for the audience member or the host, as the case may be, to navigate to a website. The information sharing service may be cloud-based, so any audience member or host may access the information sharing service from a website implementation at one time and from an application implementation another time.

The host may provide information and content, as defined above, to the information sharing service. The host may select a keyword unique to the host information via the information sharing service. The keyword should be unique to the host information. In an embodiment, the keyword is an alphanumeric keyword (includes only alphanumeric characters). In one embodiment, the host information may be stored in an information sharing database and associated with the keyword. In another embodiment, instructions to share host information with an audience member in real-time may be stored in an information sharing database and associated with the keyword. In yet another embodiment, some host information may be stored in an information sharing database and associated with the keyword in combination with instructions to share host information with an audience member in real-time. One host may have more than one set of host information, each set of host information being associated with its own unique keyword. The host may provide the audience with the keyword and the web address or location of the application download, as the case may be, to the information sharing service when requesting that the audience engage in information sharing with the host. The information sharing service may request that each audience member enter the keyword and, if the host desires, each audience member's own information or content. The host may require, at the discretion of the host, an audience member to provide audience member information or content before receiving access to the host information or content. Each audience member then enters the keyword and any other requested information or content into the information sharing service, which triggers a query of the information sharing database for the host information associated with the keyword. The host information may then be provided to each audience member that entered the keyword and any additional requested information or content via the information sharing service, while the audience member information may be provided to the host via the information sharing service.

The following detailed description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope of the invention and additional fields in which embodiments would be of significant utility. Therefore, the detailed description is not meant to limit the invention to the embodiments described below.

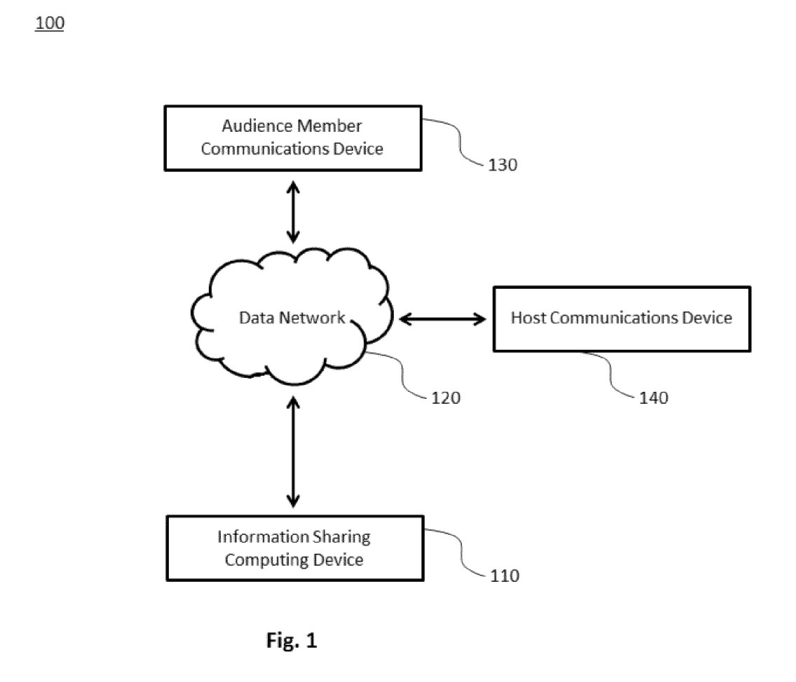

FIG. 1 illustrates an information sharing network environment 100. Information sharing network environment 100 includes an information sharing computing device 110, a data network 120, an audience member communications device 130, and a host communications device 140.

One or more audience member communications devices 130 may connect to one or more information sharing computing devices 110 via data network 120. Audience member communications device 130 may represent one or more of a mobile telephone; a smart telephone; a portable computing device; a wearable computing device, such as a computing device incorporated within a pair of glasses, a watch, and the like; a tablet; another computing device, such as a personal computer, a laptop, or a desktop computer; or any other suitable communications device that will be apparent to those skilled in the relevant art(s) without departing from the spirit and scope of the invention. An audience member communications device 130 is typically a device that includes a processor, a memory, a user interface, and a network interface, hereinafter referred to as a communications device.

One or more host communications devices 140 may connect to one or more information sharing computing devices 110 via data network 120. Host communications device 140 may represent one or more of a mobile telephone; a smart telephone; a portable computing device; a tablet; another computing device, such as a personal computer, a laptop, or a desktop computer; or any other suitable communications device that will be apparent to those skilled in the relevant art(s) without departing from the spirit and scope of the invention. A host communications device 140 is typically a device that includes a processor, a memory, and a network interface, hereinafter referred to as a communications device.

The information sharing service described herein may reside upon one or more computer servers and, in one embodiment, may be cloud-based or internet-based. As such, a host and one or more audience members may each access the information sharing service via data network 120 from one or multiple host communications devices 140 or audience communications devices 130, depending on the context. For example, any such host or audience member might choose to access the information sharing service from a laptop computer at home, a desktop computer at work, and a smart phone or tablet while commuting. The information sharing service may be accessed via a web browser on one device and accessed via a downloadable application on another device. For example, a host may choose to access the information sharing service via a web browser on a desktop computer and an application on a smart phone. Likewise, one audience member may choose to access the information sharing service via only one such method, while another audience member may choose to access the information sharing service similar to the host. This type of configuration will be apparent to one skilled in the art.

In an embodiment, audience member communications device 130 and host communications device 140 may communicate with information sharing computing device 110 via data network 120. Data network 120 may include one or more computer networks, such as the Internet. In some embodiments of the present invention, data network 120 may include one or more wide area networks (WAN) or local area networks (LAN). Data network 120 may utilize one or more network technologies such as Ethernet, Fast Ethernet, Gigabit Ethernet, virtual private network (VPN), remote VPN access, cellular data networks including 3G and 4G networks, a variant of IEEE 802.11 standard such as Wi-Fi, and the like. Communication over data network 120 takes place using one or more network communication protocols including reliable streaming protocols such as transmission control protocol (TCP). These examples are illustrative and not intended to limit the present invention. In another embodiment, audience member communications device 130 and host communications device 140 may communicate directly with each other, such as by ad-hoc networking, Bluetooth, and/or Wi-Fi Direct networking.

Information sharing computing device 110 may comprise any type of processing or computing device, such as those described above. For example, information sharing computing device 110 may be a workstation, mobile device, computer, cluster of computers, set-top box, or other computing device. In an embodiment, multiple modules may be implemented on the same computing device. Such a computing device may include software, firmware, hardware, or a combination thereof. Software may include one or more application on an operating system. Hardware can comprise a processor, memory, and/or graphical user interface display.

Information sharing computing device 110 may also include one or more conventional web servers, e-mail servers, or file transfer servers configured to provide functions of the various embodiments of the present disclosure. In one embodiment, information sharing computing device 110 may be implemented as a client that includes a browser, such as an information sharing website. The browser implemented on information sharing computing device 110 may be any browser capable of accessing the Internet; such a suitable browser will be apparent to those skilled in the relevant art(s) without departing from the spirit and scope of the invention. The components of the browser may be downloaded from a server, such as a web server, and run with the browser. For example, the components of the browser may be Hypertext Markup Language (HTML), JavaScript, or a plug-in, perhaps running native code. Alternatively, information sharing computing device 110 may be implemented as a client that includes a stand-alone application, such as a downloadable mobile application. In an embodiment, the information sharing computing device 110 may be part of or incorporated into the host communications device 140 and/or the audience member communications device 130, depending upon how the components are implemented and/or programmed.

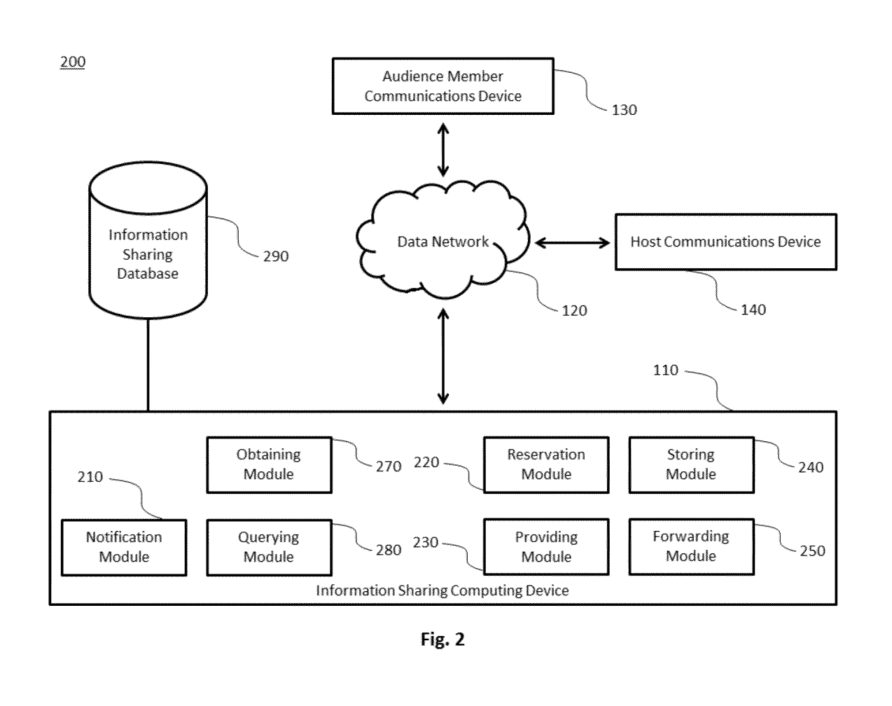

FIG. 2 depicts a detailed view of an exemplary information sharing configuration 200 for sharing information between a host and an audience. Information sharing configuration 200 includes audience communications device 130, host communications device 140, data network 120, information sharing computing device 110, and information sharing database 290. In an exemplary embodiment, information sharing computing device 110 includes an obtaining module 270, a reservation module 220, a storing module 240, a forwarding module 250, a providing module 230, a querying module 280, and a notification module 210.

Information sharing computing device 110, audience member communications device 130, host communications device 140, and information sharing database 290 may share resources via data network 120. For example, information sharing computing device 110 may retrieve host information from information sharing database 290. Audience member communications device 130 may provide audience member information to information sharing database 290 via data network 120. Host communications device 140 may provide host information to information sharing database 290 via data network 120. Based on the cloud computing configuration, the interaction between information sharing computing device 110, audience member communications device 130, host communications device 140 and information sharing database 290 may not be limited to a single computing device. For example, a plurality of computing devices may update information sharing database 290 via data network 120 with host information and/or audience member information. For the purpose of the current disclosure, when it is described herein as a “host” performing any particular action with respect to the information sharing service, the host will be interacting with the information sharing service using the host communication device 140, which is connected (by a data connection) to the data network 120; likewise, when it is described herein as an “audience member” performing any particular action with respect to the information sharing service, the audience member will be interacting with the information sharing service using the audience member communications device 130, which is connected (by a data connection) to the data network 120.

Information sharing computing device 110 may enable the host to easily share the host's information with the audience and, in some embodiments, to receive information from one or more audience members. Information sharing computing device 110 may implement an information sharing website as a platform for sharing information between the host and the audience. The information sharing website may be easily accessed by audience member communications device 130 and/or host communications device 140. The information sharing website does not require that the host or audience first download an application onto any of their respective audience member communications device 130 and/or host communications device 140 before sharing information. Rather, the information sharing website includes browser capability so that any type of communications device or computing device with a web browser may access the information sharing website. In another embodiment, information sharing computing device 110 may implement a downloadable application to audience member communications device 130 and/or host communications device 140 as a platform for sharing information between the host and the audience. Such an implementation may be more convenient on some devices, such as smart phones, than a website. Any host or audience member may access information sharing service sometimes via the information sharing website and other times via an application depending on the preferences and conveniences of such host or audience member.

Obtaining module 270 provides the host access to an information sharing service that may be supported by the information sharing computing device 110. The host may enter the information sharing service with the purpose of being able to easily share the host's information with audience members and, if desired, to receive information from each audience member. The host and audience can share a wide variety of information and content, as previously illustrated. The obtaining module 270 may request that the host sign up or sign-in as a member of the information sharing service in which the host may have to provide a username and password in order to continue to access the information sharing service. The host may also have to provide an email address or other personal information in order to properly register with the information sharing service. In another embodiment, a host may not be required to formally register as a member of the information sharing service. In this case, a host may simply send to a pre-determined email address an email containing the information the host wishes to share, either in the body of the email or as one or more attachments. The host would then receive an email containing an automatically-generated, short-term keyword, which could be random or automatically selected to be related to the subject matter of the host information.

After the host has registered or signed-in as a member of the information sharing service, obtaining module 270 may prompt the host to enter information into an information page. In one embodiment, the information page may be a profile for the host that includes a plurality of different fields for the host to enter and upload information. The information entered into the information page by the host may be the information that the host requests to easily share with the audience. The information page may include any information or content that the host would like the audience to have so that the host may continue to foster the relationship between the host and the audience. The information page may include information about products sold or recommended by the host, links to external sites offering such products for sale, or functionality to make a sale directly from the information sharing service. The information page may also include a profile picture of the host or other similar media. For example, the information page may include fields that the host may enter information and content into such as, but not limited to, the host's contact information such as name, address, email address, cell phone number, web page, social media addresses, and so on so that the audience may be able to continue to follow the host's activity. The information page may also provide the host the opportunity to upload files, such as presentations, handouts, videos of the host's performances, documents useful for a meeting, and so on. The host may also choose to embed social media tools within the information page. The social media outlets that may be supported by the information sharing browser may include, but are not limited to, Facebook, Twitter, MySpace, LinkedIn, Google Plus, Drop Box, YouTube, and any other social media outlet that will be apparent to those skilled in the art without departing from the spirit and scope of the present disclosure. The host may choose to host message forums for audience members to post and converse as well as picture boards where audience members can upload pictures, videos, and otherwise interact with each other. The host may ask questions and solicit answers from audience members, and the host may conduct polling, all from the information page. In another embodiment, the host may only provide instructions sufficient to set up a future real-time interaction between the host and an audience. In yet another embodiment, the host may enter some information into an information page in advance and provide instructions to set up a future real-time interaction between the host and an audience. The host may push content to the information page in real-time, even when audience members are viewing the information page. For example, a host in a sporting event context may coordinate cheers from the audience, and a host in a band context may coordinate a light show on audience member communications devices 130. Generally, the host may control what the audience may see and access, as well as how the audience members may interact, both with the host and with each other, by the information sharing service.

Reservation module 220 may reserve a keyword associated with the host information that is unique to the host information. A host selects the keyword that the reservation module reserves. It is possible for one host to reserve different keywords, each of which corresponds to a different set of host information. Reservation module 220 may prompt the host to select a keyword that is unique to the host and not currently being used by another host also registered at the information sharing service. The keyword may be any length, including multiple words, and may include numbers, other alpha-numeric characters, and/or characters commonly associated with a standard keyboard. In some embodiments, the keyword is limited to one word. The keyword may be only associated with the host information and no other host's information. The keyword may be what the host provides to the audience so that the audience may easily access the host's information via the information sharing service. The keyword may be easily remembered by the audience. Each audience member may then browse to the information sharing service, enter the keyword when prompted by the information sharing service, then have access to the host information that the host entered into or uploaded onto the information sheet. Keywords may be time-limited. For example, a host may choose to only reserve a keyword for the duration of a particular event. Additionally, a previously-reserved keyword may become available for others to use if a host fails to maintain a membership with the information sharing service. Such memberships may be associated with a host generally or with a specific set of host information specifically.

After the host has selected the keyword, storing module 240 may store the host information and the associated keyword in information sharing database 290 associated with the information sharing service. For example, the information sharing database 290 may be a SQL database where the information stored in the information sharing database is associated with the keyword. The host information associated with another host who is a member of the information sharing service is stored in the information sharing database 290 under a keyword unique to the other host's information. Each host may choose to store multiple sets of host information, each associated with a unique keyword, particularly if a host targets multiple, discrete audiences.

Querying module 280 may query the host information based on the keyword from the information sharing database 290 associated with the information sharing service. After the host has provided the keyword to the audience, each audience member may then enter the information sharing service to access the host information. Each audience member may or may not be required to register and log in with the information sharing service in order to access the host information. Each audience member may simply browse to the information sharing service and then enter the keyword provided by the host when prompted by the obtaining module 270. Querying module 280 may then query the information sharing database 290 for the host information associated with the keyword.

After the querying module 280 queries the information sharing database 290 for the appropriate host information associated with the keyword, providing module 230 may provide the host information to the audience member via the information sharing service. In some embodiments, providing module 230 may provide the host information onto a template form or downloadable file. For example, providing module 230 may provide the host's contact information on a virtual contact card. Providing module 230 may also provide any other information that the host had entered or uploaded to the information sheet so that the audience member may download the information onto the audience member communications device 130 or view the information via the information sharing service. The host may control whether to allow an audience member to download host information or only allow the host information to be viewed via the information sharing service. Generally, providing module 230 may provide the audience any information that the host chose to enter or upload. Providing module 230 may provide to the audience member the host information via a web-based download. Providing module 230 may also provide to the audience member the host information via an email. In embodiments involving a real-time exchange of host information and audience member information, providing module 230 may provide the audience member with a substantially blank page on which information may be exchanged between a host and an audience member. In further embodiments, providing module 230 may provide an audience member basic host information that may change or become updated once a real-time interaction between the host and the audience member begins.

In an embodiment, the host may request information from each audience member in exchange for the host information. In order to adequately continue to foster the relationship between the host and the audience, the host may request to have information from each audience member that requests the host information. The host may request any type of information from the audience. The host may choose not to request any information, may choose to define what information the host desires when the host is entering or uploading the host's own information, or the host may edit whether or not to request audience information or the types of information at any time. For example, the host may enter into the information sheet that the host requests each audience member's name and email address in exchange for the host information. When an audience member accesses the information sharing service and enters the keyword associated with the host's information, obtaining module 270 may prompt the audience member for the desired information as a prerequisite to providing module 230 providing the audience member with the host information. In some embodiments, the information sharing service may provide the host suggestions regarding what information to share and request from the audience based on the context. In some embodiments, the host may require each audience member to participate in a real-time exchange of information as a prerequisite to receiving further information. In other embodiments, the host may customize what information the host shares and requests from the audience. The host may incentivize the exchange of information by offering incentives to the audience with the hope that each audience member accesses the information sharing service, enters the appropriate keyword, and enters any requested audience member information in exchange for the host's information. For example, in the appropriate contexts, the host may offer the audience incentives, such as half-priced tickets, to see the host again or coupons for discounts on products sold by the host. As a result, upon obtaining audience member information or upon an audience member's participation in a real-time exchange of information, the host may provide updates and/or incentives to the audience member via email or social media outlets. Additionally, once a host and an audience member connect via the information sharing service, the information sharing service may notify the host or audience member about any relevant updates or new content directly via the information sharing service.

Once the audience member accesses the information sharing service, enters the appropriate keyword as prompted by obtaining module 270, and enters the requested audience information as prompted by obtaining module 270, if the host requests such information, querying module 280 may then query the information sharing database 290 for the host information associated with the keyword. Providing module 230 may then provide the host information to the audience member via the information sharing service. Such exchange of information may occur either all at once or as part of a continuous, real-time information exchanging experience.

The host may designate a time limit that limits the available time for providing module 230 to provide the host information to the audience. The host may not wish for providing module 230 to provide the host information to the audience for an indefinite period of time. Rather, the host may request to set a time limit within which providing module 230 may provide the host information to the audience. Before the time limit has expired, providing module 230 may provide the host information to each audience member that provides the appropriate keyword. After the time limit has expired, if one is set, providing module will no longer provide the host information to any audience member even if the audience member has provided the appropriate keyword. In such an embodiment, the host may still remain a registered participant of the information sharing service. However, in such a case, the audience is no longer being provided presenter information upon entry of the keyword. The host retains discretion as to whether to impose a time limit, and the host may add, edit, or remove a time limit as long as the host remains registered with information sharing service.

After the audience member provides the audience member information to obtaining module 270, storing module 240 may store the audience member information based on the keyword in the information sharing database 290 associated with the information sharing service. Storing module 240 may store the audience member information in the information sharing database 290 under the keyword provided by the audience member and associated with the host's information. Storing module 240 may encrypt the audience member information in information sharing database 290 and attach the host information to the encrypted session identification for the audience member. Once the audience information is stored in information sharing database 290, the host can access the audience information via the information sharing service.

In another embodiment, the audience member information may be stored as a cookie on audience member communications device 130 after the audience member enters the audience member information into obtaining module 270 rather than storing the audience information in information sharing database 290. The audience member information may alternatively be stored on audience member communications device 130 via HTML5 web storage.

The audience members may also use social media outlets that have their audience member information already stored to populate the information request from obtaining module 270 rather than manually keying in the audience member information to obtaining module 270. After audience member information has been entered to obtaining module 270, obtaining module 270 may not request the same audience member information for later requests for the same audience member information. Rather, obtaining module 270 may automatically display the previously entered audience member information. In another embodiment, obtaining module 270 may hide the previously entered audience member information when requested by the audience member.

After the audience member has provided the appropriate keyword and any requested audience member information to obtaining module 270, the host and audience member may exchange short messages between each other. The host and audience member may also be able to provide feedback to each other. The host may have customized questions included in the information page that are presented to the audience member to answer. The audience member may answer the questions when requested by obtaining module 270 to provide the audience member information in order to access the host information. The audience member may also have an open field included in the information page of the audience member to provide a message to the host. The host may view the message when provided the information page of the audience member. The host may have provided a message board on which audience members can post and interact with the host and each other. The host may have also provided other ways for the audience members to interact with each other; for example, the host may choose to allow audience members to upload photos and videos to the host's information page. In an embodiment, host information may be stored in advance and accessed all at once by an audience member. In another embodiment, host information may be stored in advance, and the information sharing service may be configured so that an audience member may access certain host information at certain times. In yet another embodiment, host information and audience member information may be mutually exchanged in real-time. By fostering the interest of audience members in each other, the host may also foster interest in the host.

Further, forwarding module 250 may forward the audience member to a host website. The host website may be a personal website for the host that is external to the information sharing service. In another embodiment, the host website may simply be a personal profile page within or affiliated with the information sharing service. Forwarding the audience member by forwarding module 250 to the host website may ease the share of information between the host and the audience member. The host is not required to communicate the website address of the host website. The audience member is not required to receive the website address of the host website and then key the website address into the web browser of the audience member before finally reaching the host website. Rather, forwarding module 250 automatically forwards the web browser of the audience member to the host website after the audience member has provided the appropriate keyword and requested audience member information.

Notification module 210 may notify the host when an audience member has received the host information from the information sharing service. After the audience member has provided audience member information to obtaining module 270 and providing module 230 has provided the host information to the audience member, notification module 210 may notify the host that the audience member completed the requisite steps, as previously described, to access the host information. Notification module 210 may notify the host via email of each time an audience member receives the host information. However, the host may have provided the keyword to a significantly large audience and may not wish to receive an email each time an audience member receives the host information. As a result, notification module 210 may also provide the host a live feed to host communications device 140 rather than individual emails. Notification module 210 may also notify the audience member in a similar fashion discussed above when the audience member provides their email address to obtaining module 270.

Providing module 230 may provide the host with the audience member information from each audience member that provided the appropriate keyword and the requested audience member information to obtaining module 270. Providing module 230 may display the audience member information to the host via the information sharing service. Providing module 230 may also email the audience member information for each audience member to the host. In some contexts, providing module 230 may provide the audience member information onto a template form or downloadable file. For example, providing module 230 may provide the audience member's contact information on a virtual contact card. Providing module 230 may also provide any other information that the audience member had entered or uploaded to the information sheet so that the host may download the information onto the host communications device 130 or view the information via the information sharing service. In an embodiment, providing module 230 may provide audience member information to the host in real-time.

However, as noted above, the host may present to a significantly large audience. The host may not want to receive an individual email for each individual audience member. Further, the host may not be able to easily analyze or extract the information of each audience member contained in a large plurality of emails without wasting an undue amount of time. As a result, providing module 230 may accumulate the audience member information for each of the individual audience members into a downloadable file. Providing module 230 may also provide aggregate audience member information into any desired format, for instance, where the host and the audience engaged in real-time information exchanges, such as live polling. The host may download the file from the information sharing service onto host communications device 140 and utilize the audience member information of each audience member from a single file. Providing module 230 may also provide the accumulated audience member information to the host's mailing service so that emails or stamped mail may be generated and delivered to each audience member by the host's mailing service. Providing module 230 may also add the audience member information into the contact book of the host as supported by host communications device 140. Providing module 230 may also notify the audience member in a similar fashion discussed above when the audience member provides their email address to obtaining module 270.

In an embodiment, information sharing computing device 110 may be based on a mobile application, such as a Rubion Software application. After obtaining module 270 has received the host information and/or audience member information, information sharing computing device 110 attaches a gem in the Rubion Software application that creates a virtual contact card. The virtual contact card may then be emailed to the host and/or audience member. The host and/or audience member may then one click download the virtual contact card into their respective contacts included in their respective host communications device 140 and/or audience member communications device 130. The encryption of the host information and audience member information may be done via Secure Socket Layer (SSL) encryption or any other suitable encryption method known to those having ordinary skill in the art. In an embodiment, the host and/or audience may be able to detect other hosts and/or audience members that are sharing information in a nearby geographic location based on Global Positioning System (GPS) coordinates, Bluetooth connectivity, ad-hoc networking, and/or device orientation of each respective host's and/or audience member's audience member communications device 130 and/or host communications device 140.

In an embodiment, the functionality mentioned above regarding storing module 240 and querying module 280 relative to information sharing database 290 may be substituted by ad-hoc networking, Bluetooth, and/or Wi-Fi Direct networking between audience member communications device 130 and host communications device 140. Rather than storing the host information and/or the audience member information on information sharing database 290, the host information and/or the audience member information may be stored on audience member communications device 130 and/or host communications device 140. The host information and/or the audience member information may be stored on audience member communications device 130 and/or host communications device 140 via the keyword. Audience member communications device 130 and/or host communications device 140 may then be queried for the host information and/or audience member information via the keyword. Host information may then be delivered directly from host communications device 140 to audience member communications device 130 via ad-hoc networking, Bluetooth, and/or Wi-Fi Direct networking and may not require storage of host information on an information sharing database 290. Audience member information may then be delivered directly from audience member communications device 130 to host communications device 140 via ad-hoc networking, Bluetooth, and/or Wi-Fi Direct networking and may not require storage of audience member information on an information sharing database 290.

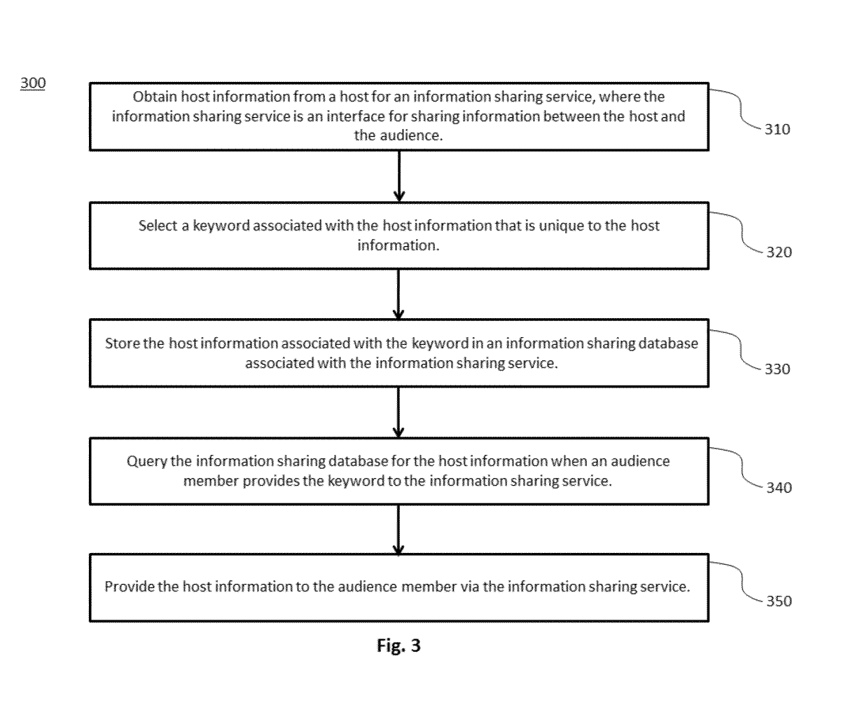

FIG. 3 is a flowchart showing an exemplary method 300 for sharing information from a host to an audience, wherein the information is linked with a keyword that connects the host to the audience. As shown in FIG. 3, method 300 begins at stage 310 when a processor obtains host information from a host for an information sharing service. The information sharing service includes an interface for sharing information between the host and the audience. For example, as shown in FIG. 2, obtaining module 270 obtains host information from a host for an information sharing service via data network 120. The information sharing service includes an interface for sharing information between one or more audience member communications devices 130 and one or more host communications devices 140. Stage 310 can be performed by, for example, obtaining module 270.

At stage 320, the processor reserves a keyword associated with the host information that is unique to the host information and may be selected by the host. Stage 320 can be performed by, for example, reservation module 220. For example, as shown in FIG. 2, reservation module 220 reserves a keyword associated with the host information that is unique to the host information.

At stage 330, the processor stores the host information associated with the keyword in an information sharing database associated with the information sharing service. Stage 330 can be performed by, for example, storing module 240. For example, as shown in FIG. 2, storing module 240 may store the host information associated with the keyword in information sharing database 290 associated with the information sharing service.

At stage 340, the processor queries the information sharing database for the host information when an audience member provides the keyword to the information sharing service. Stage 340 can be performed by, for example, querying module 280. For example, as shown in FIG. 2, querying module 280 queries information sharing database 290 for the host information when an audience member provides the keyword to the information sharing service.

At stage 350, the processor provides the host information associated with the keyword entered by the audience member to the audience member via the information sharing service. Stage 350 can be performed by, for example, providing module 230. For example, as shown in FIG. 2, providing module 230 provides the host information to the audience member via the information sharing service.

Embodiments can work with software, hardware, and/or operating system implementations other than those described herein. Any software, hardware, and operating system implementations suitable for performing the functions described herein can be used. Embodiments are applicable to both a client and to a server or a combination of both.

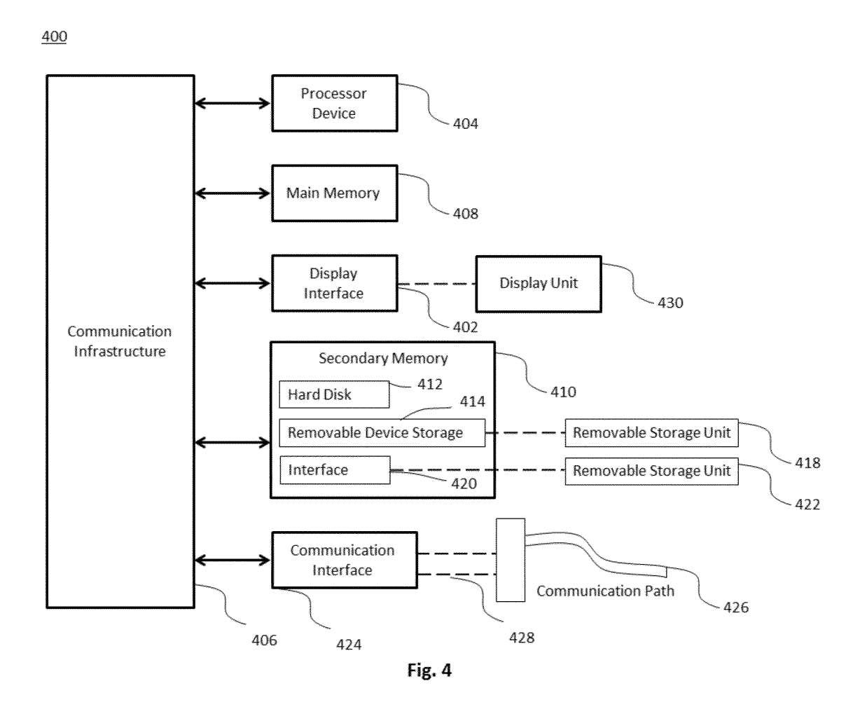

FIG. 4 illustrates an exemplary computer system 400 in which embodiments of the current disclosure, or portions thereof, may be implemented as computer-readable code. For example, information sharing computing device 110 may be implemented on computer system 400 using hardware, software, firmware, tangible computer readable media having instructions stored thereon, or a combination thereof and may be implemented in one or more computer systems or other processing system.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various embodiments of the invention are described in terms of this exemplary computer system 400. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, a computing device may have one or more processors, such as processor device 404, where the processor device may be a single processor, a plurality of processors, a processor in a multicore/multiprocessor system, such system operating alone, or in a cluster of computing devices operating in a cluster or server farm. Processor device 404 is connected to a communication infrastructure 406, for example, a bus, message queue, network, or multi-core message-passing scheme.

Computer system 400 also includes a main memory 408, for example, random access memory (RAM), and may also include a secondary memory 410. Secondary memory 410 may include, for example, a hard disk drive 412, removable storage drive 414. Removable storage drive 414 may include a floppy disk drive, a magnetic tape drive, an optical disk drive, a flash memory, or the like. The removable storage drive 414 reads and/or writes to a removable storage unit 418 in a well-known manner. Removable storage unit 418 may include a floppy disk, magnetic tape, optical disk, etc. which is read by and written to by removable storage drive 414. As will be appreciated by persons skilled in the relevant art, removable storage unit 418 includes a computer readable storage medium having computer software and/or data stored therein.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interfaces 424 may include a modem, a network interface (such as an Ethernet card), a communications port, a PCMCIA slot and card, or the like. Software and data transferred via communications interface 424 may be in the form of signals, which may be electronic, electromagnetic, optical, or other signals capable of being received by communications interface 424. These signals may be provided to communications interface 424 via a communications path 426.

In this document, the terms “non-transitory memory,” “computer program storage medium,” and “computer usable storage medium” are used to generally refer to storage media such as removable storage unit 418, removable storage unit 422, and a hard disk installed in hard disk drive 412. Non-transitory memory, computer program storage medium, and computer usable storage medium may also refer to memories, such as main memory 408 and secondary memory 410, which may be memory semiconductors (e.g. DRAMS, etc.).

Computer programs (also called computer control logic) are stored in main memory 408 and/or secondary memory 410. Computer programs may also be received via communications interface 424. Such computer programs, when executed, enable computer system 400 to implement embodiments as discussed herein. In particular, the computer programs, when executed, enable processor device 404 to implement the processes of the disclosure, such as the stages in the method illustrated by flowchart 300 of FIG. 3 discussed above. Accordingly, such computer programs represent controllers of the computer system 400. When an embodiment is implemented using software, the software may be stored in a computer program product and loaded into computer system 400 using removable storage drive 414, interface 420, and hard disk drive 412, or communications interface 424.

The following paragraphs are intended to illustrate the breadth of possible applications of various embodiments of a system for sharing information as described herein, such as who may be considered a host, who may be considered an audience, and what kinds of information may be exchanged. Examples of information that may be exchanged are merely illustrative; such examples are not intended to limit the scope of information shared in a particular use. Rather, a host retains discretion as to what type of information to share, what type of information to request, and what type of content, forums, and the like to include that may allow an audience to interact with the host and with each other. Additionally, information and content exchanged via an information sharing service may be determined in advance or may be shared in real-time. Such exemplary uses are inclusive, and one of ordinary skill in the relevant arts may recognize additional applications and uses that fall within the spirit and scope of this disclosure.

A host may be a presenter at a conference or seminar. For example, such a presenter could be a motivational speaker, a professional speaker, a presenter presenting at a professional development seminar, a trainer or presenter at a professional education or certification event, an academic giving a presentation on research results or current developments in his or her field of study, a salesperson delivering a pitch, a presenter at a conference, a TED talk presenter, or other similar presenter or speaker. The audience, collectively, may comprise those listening to the presenter. Additionally, the audience may comprise those interested in the subject matter of the presentation, seminar, conference, pitch, or speaking engagement. In such a setting, the presenter may use an information sharing service as follows: to provide digital information to the audience, such as notes, handouts, audio files, videos, biographical information of the presenter, and registration forms; to provide the audience with the contact information of the presenter; to sell products to the audience, either directly from the information sharing service or by providing a link to a seller external to the information sharing service; to poll the audience, including in real time; to provide presentations to the audience to enable the audience to follow along; or combinations thereof. Additionally, the presenter may wish to receive information from the audience, such as the contact information of the audience members, feedback from the audience regarding the presentation, and so on.

A host may be an entertainer such as a band or singer, magician, comedian, or other person or group that performs at a show, concert, or like event. An entertainer may also give a spontaneous performance, play on a city street, perform at an “open mic” night, or otherwise entertain a person or group of people. The audience may comprise any concert attendee, show attendee, or like event attendee or a listener or viewer of a less formal performance. The audience may further comprise any fan of the entertainer. In such a setting, the entertainer may use an information sharing service as follows: to provide digital information to the audience, such as audio files, announcements, set lists, schedules, videos, and incentives, such as discounted tickets to future shows; to provide the audience with the social media information of the entertainer; to sell products to the audience, either directly from the information sharing service or by providing a link to a seller external to the information sharing service; to poll the audience, including in real time; to provide the audience with a place to post pictures or videos, such as fan “selfies” at an event; to allow the audience to view social media information, especially such information related to an event, show, or performance; or combinations thereof. An entertainer may wish to coordinate audience member devices to add entertainment value to a performance, such as coordinating a light show using audience member communications devices. An entertainer, particularly a singer or band, may wish to provide the audience with lyrics in order to enable the audience to sing along. Additionally, the entertainer may wish to receive information from the audience, such as the contact information of the audience members, feedback from the audience regarding the performance, and so on.

A host may be a station, such as a TV station or a radio station. An event may be any program produced by the station, contest held by the station, or other scenario in which the station wishes to interact with the audience. Many stations are on-air nearly continuously, so an event in this case may have no set time or place. The audience may comprise any listener or viewer of the station. In such a setting, the station may use an information sharing service as follows: to provide digital information to the audience, such as audio files, videos, and biographical information, such as descriptions of program guests; to provide the audience with the social media information of the station; to advertise; to poll the audience, including in real time; to provide the audience with a place to post pictures and videos; to provide games or trivia for the audience; to alert the audience of contests and allow the audience to participate in such contests; to allow the audience to view social media information, including a station's social media posts or feeds; or combinations thereof. Additionally, the station may wish to receive information from the audience, such as the contact information of the audience members, pictures, videos, written posts, feedback from the audience regarding programs, and so on.

A host may be a church, including an independent church, a church affiliated with a religious organization, or a leader thereof. A church may wish to provide an audience information not only during a service, but also during the week. An audience may comprise members of the church, attendees of the church, and individuals simply interested about the church or in the information disseminated by the church. A church might use an information sharing service as follows: to disseminate digital information, such as audio files, presentations, videos, sheet music, hymn lyrics, and written sermons; to circulate prayer chains; to update the audience with current events; to post links to websites; and to provide regularly updated information. A church may wish to collect audience members' contact information, preferences regarding preaching style or music choice, prayer requests, donations, and other like information. A church may wish to provide a forum for community discussion.

A host may be an advertiser, such as an advertiser advertising on a TV station, billboard, or a radio station. The audience may comprise any listener or viewer of the advertisement. In such a setting, the advertiser may use an information sharing service as follows: to provide digital information related to whatever might be advertised; to provide incentives, including coupons, to the audience; to poll the audience, including in real time; to provide the audience with a place to post pictures and videos; to provide games or trivia for the audience; to alert the audience of contests and allow the audience to participate in such contests; to allow the audience to view social media information, including an advertiser's social media posts and feeds; or combinations thereof. Additionally, the advertiser may wish to receive information from the audience, such as the contact information of the audience members, preferences of the audience, pictures, videos, written posts, feedback from the audience regarding the subject matter of the advertisements, and so on.

A host could be a meeting organizer. A meeting organizer may be one who calls a corporate meeting, a teacher in a classroom setting, a club leader, or another similar person that gathers a group in order to, at least in part, share information. An audience in this case may comprise anyone who attends a gathering, event, or meeting called by any such meeting organizer. A meeting may use an information sharing service as follows: to provide digital information, such as presentations, assignments, work or educational materials, notes, handouts, audio files, videos, and other electronic files, to an audience; to give updated, specific information to an audience, such as announcements, agendas, lists, etc.; to provide a message board or other central communications hub for an audience to digitally connect with each other and share thoughts, pictures, documents, and other similar items; to collect information from audience members, in advance or in real time, such as contact information, feedback and thoughts regarding the meeting or event, interest in future meetings or events, attendance, any electronic files required by the meeting organizer, and answers to polls or questions posed live; and to provide a central social media hub with which the audience may interact, read, or post. Audience members may be able to collaborate with each other digitally on projects in real time.

A host may be a community organizer. A community organizer may be a fundraiser, an organizer of youth camps or related events, an organizer of community events such as fireworks nights or parades, a flash mob organizer, or a rally organizer, such as a leader of a protest movement, picket, strike, or other cause. An audience may comprise a member of the relevant community or an attendee of an event organized by such a community organizer. A community organizer may use an information sharing service as follows: to provide digital information to an audience, such as registration forms, notes, handouts, fliers, audio files, videos, and other electronic files; to provide descriptive information to an audience, such as information about an event, camp, organization, protest, or cause; to provide an audience with agendas, announcements, schedules, parking information, and answers to frequently asked questions; to provide weather information to an audience; to advertise; to provide real-time content to audience member devices, including any content that would allow an audience member to interact with an event; to collect contact information, feedback, interest regarding future events, attendance, and electronic files from audience members; to conduct polling of the audience; to allow an audience to post messages, audio clips, videos, pictures, and the like; to solicit donations, including donations that may be made directly via the information sharing service; and to provide centralized social media connectivity to an audience, particularly social media content related to a particular event.

A host may be a sports organization. A sports organization may include sports teams, including major and minor league sports teams, youth sports teams, and tournament organizers. An audience may comprise any team member, family of a team member, tournament participant, fan, or spectator. A sports organization may use an information sharing service as follows: to provide digital information to an audience, such as handouts, registration forms, audio files, videos, and any other electric files that a sports organization wishes to share; to provide descriptive information to an audience, such as information about a tournament, schedules, directions, parking information, announcements, and frequently asked questions; to provide incentives to an audience, such as discounted tickets in the case of a professional sports organization or concession credits; to advertise; to provide real-time and interactive content to an audience, such as updated scores, schedule changes, announcements, parking updates, media content, play-by-play updates, standings, dependent content such as statistics corresponding to a current batter in a baseball game, and audio broadcasting; to collect information from an audience, such as contact information, feedback, reservations, interest regarding future events, attendance, answers to polls or specific questions, audio content, video content, pictures, and messages; to provide a central hub that may provide social media content, links to external sites, games and trivia, and forums for audience members to interact with each other via messages, pictures, and video; and to push real-time content to an audience, such as a coordinated cheer and a countdown until the cheer is to begin.

A host may be a retail store such as a commercial merchant or a restaurant. An audience may include consumers of the store or members of a target market of the store. A store may use an information sharing service as follows: to provide digital information to an audience, such as fliers, coupons, audio files, videos, or other electronic files; to provide descriptive information, such as item availability or menu options; to provide a reservation system for an audience; to provide an audience with incentives and updates regarding promotions; to advertise; to provide real-time information, such as wait times and checkout line status; to collect information from an audience, such as contact information, feedback, interest in future offerings or merchandise; to provide a frequent user rewards system; to collect payments; and to provide relevant news and social media content. Furthermore, a store may offer sales and accept delivery orders and payments through the information sharing service.

A host may be a teacher, such as an elementary school teacher, a high school teacher, or a college professor. In this scenario, an audience may be one or more students. A teacher may use an information sharing service as follows: to provide digital information to an audience, such as documents, notes, handouts, pictures, sound clips, videos, and registration forms; to post one or more questions that the teacher wants answered, either on the students' time or in real time; to conduct polling, either over an extended time or in real time; to provide digital versions of classroom notes, lectures, and/or presentations; to provide links to websites that are external to the information sharing service; and to post assignments.

### CONCLUSION

The Brief Summary and Abstract sections may set forth one or more but not all exemplary embodiments and thus are not intended to limit the scope of the present disclosure and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptation and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Following from the above description summaries, it should be apparent to those of ordinary skill in the art that, while the methods, apparatuses and data structures herein described constitute exemplary embodiments of the current disclosure, it is to be understood that the inventions contained herein are not limited to the above precise embodiments and that changes may be made without departing from the scope of the invention as claimed. Likewise it is to be understood that it is not necessary to meet any or all of the identified advantages or objects of the invention disclosed herein in order to fall within the scope of the inventions, since inherent and/or unforeseen advantages of the current disclosed embodiments may exist even though they may not have been explicitly discussed herein.

What is claimed is:

1. A system for sharing information from a host to an audience based on a keyword that links the host to the audience, comprising:
a processor; and
a memory coupled with the processor, the memory including instructions that when executed by the processor, cause the processor to:
obtain host information from a host communications device for an information sharing service, wherein the information sharing service includes an interface for sharing information between the host communications device and one or more audience member communications devices;
reserve a keyword associated with the host information that is unique to the host information;
store the host information based on the keyword in an information sharing database associated with the information sharing service;
receiving the keyword from an audience member communications device;
query the information sharing database for the host information upon receiving the keyword from the audience member communications device and providing the queried host information to the audience member communications device.

2. The system of claim 1, wherein the processor is further configured to prompt the host communications device with a graphical user interface information page for the host to provide the host information.

3. The system of claim 1, wherein the processor is further configured to prompt the host communications device for the keyword that is not currently being used by another host using the information sharing service.

4. The system of claim 1, wherein the processor is further configured to request from the audience member communications device that provided the keyword to further provide audience member contact information before the host information is provided to the audience member communications device via the information sharing service.

5. The system of claim 4, wherein the processor is further configured to store the audience member contact information based on the keyword in the information sharing database associated with the information sharing service.

6. The system of claim 4, wherein the processor is further configured to query the information sharing database for the host information when the audience member provides the keyword and the audience member contact information to the information sharing service.

7. The system of claim 6, wherein the processor is further configured to forward the audience member communications device to a host website for the host when the audience member communications device provides the keyword and the audience member contact information to the information sharing service, wherein the host website is selected from the group consisting of: a personal website for the host that is external to the information sharing service and a personal profile page affiliated with the information sharing service.

8. The system of claim 1, wherein the processor is further configured to notify the host communications device of the audience member that has received the host information from the information sharing service.

9. The system of claim 8, wherein the processor is further configured to:
receive audience member contact information from the audience member communications device and store the audience member contact information based on the keyword in the information sharing database associated with the information sharing service;
provide the host communications device with the audience member contact information to the information sharing service, and
provide the host communications device with a downloadable file that includes the audience member contact information.

10. The system of claim 1, wherein the processor implements the information sharing service on a website.

11. The system of claim 1, wherein the processor implements the information sharing service utilizing a dedicated application downloaded onto a user computing device.

12. A computer implemented method for sharing information from a host to an audience based on a keyword that links the host to the audience, comprising:
obtaining, by a processor, host information for a host for an information sharing service, wherein the information sharing service includes an interface for sharing information between the host and the audience;
reserving, by the processor, a keyword associated with the host information that is unique to the host information;
storing, by the processor, the host information based on the keyword in an information sharing database associated with the information sharing service;
querying, by the processor, the information sharing database for the host information when an audience member provides the keyword to the information sharing service; and
providing, by the processor, the host information queried from the information sharing database to the audience member via the information sharing service.

13. The computer implemented method of claim 12, wherein the obtaining step comprises:
prompting the host with an information page for the host to enter the host information.

14. The computer implemented method of claim 12, wherein the reserving step comprises:
prompting the host for a keyword that is not currently associated with another set of host information on the information sharing service.

15. The computer implemented method of claim 12, further comprising:
requesting from the audience member that provides the keyword to provide audience member information before providing the host information to the audience member via the information sharing service; and
storing the audience member information based on the keyword in the information sharing database associated with the information sharing service;
wherein the querying step queries the information sharing database for the host information when the audience member provides the keyword and the audience member information to the information sharing service.

16. The computer implemented method of claim 15, further comprising:
forwarding the audience member to a host website for the host when the audience member provides the keyword and the audience member information to the information sharing service, wherein the host website is selected from the group consisting of: a personal website for the host that is external to the information sharing service and a personal profile page affiliated with the information sharing service.

17. The computer implemented method of claim 12, further comprising:
notifying the host that the audience member has received the host information from the information sharing service.

18. The computer implemented method of claim 17, further comprising:
providing the host with the audience member information from the audience member that has provided the keyword and the requested audience information to the information sharing service; and
providing a downloadable file that includes the audience member information from the audience member that has provided the keyword and the requested audience information to the information sharing service.

19. A system for sharing information from a host to an audience based on a keyword that links the host to the audience, comprising:
a processor; and
a memory coupled with the processor, the memory comprising instructions that when executed by the processor, cause the processor to:
obtain host information from a host communications device for an information sharing service, wherein the information sharing service includes an interface for sharing information between the host and the audience;
reserve a host keyword associated with the host information;
store the host information associated with the host keyword in an information sharing database associated with the information sharing service;
receive, by the information sharing service, a keyword matching the host keyword from an audience member communications device via a data network;
prompt, by the information sharing service, the audience member communications device to provide audience member contact information;
query the information sharing database for the host information when an audience member communications device provides the matching keyword and the audience member contact information to the information sharing service; and
provide the host information to the audience member communications device via the information sharing service.

20. The system of claim 19, wherein the processor is further configured to prompt the host communications device with an information page for the host to enter the host information.

21. The system of claim 19, wherein the processor is further configured to request the audience member contact information from the audience member communications device after the information sharing service receives the matching keyword from the audience member communications device and before the information sharing service provides the host information to the audience member communications device.

22. The system of claim 21, wherein the processor is further configured to store the audience member contact information in the information sharing database such that the audience member contact information is associated with the host keyword.

23. The system of claim 22, wherein the processor is further configured to provide to the host communications device with a downloadable file comprising the audience member contact information.

24. The system of claim 19, wherein:
the host communications device is associated with a presenter of a live presentation; and
the host information is selected from the group consisting of: digital documents, notes, handouts, audio files, videos, registration forms, contact information, biographical information, copies of a presentation, products on sale and sold by the presenter via an external link, products on sale and sold by the presenter via the information sharing service, polls, links to social media, embedded social media widgets, and combinations thereof.

25. The system of claim 19, wherein:
the host communications device is associated with a presenter of live entertainment; and
the host information is selected from the group consisting of: digital information, audio files, announcements, set lists, schedules, videos, incentives for attendance at future events, links to social media, embedded social media widgets, products on sale and sold by the presenter via the information sharing service, products on sale and sold by the presenter via an external link, polls, a hub capable of collecting and displaying audience photographs, a hub capable of collecting and displaying audience videos, a hub capable of collecting and displaying audience messages, lyrics, and combinations thereof.

26. The system of claim 19, wherein:
the host communications device is associated with a media station; and
the host information is selected from the group consisting of: digital information, audio files, videos, biographical information, links to social media, embedded social media widgets, advertisements, polls, a hub capable of collecting and displaying audience photographs, a hub capable of collecting and displaying audience videos, a hub capable of collecting and displaying audience messages, games, trivia, announcements, contests, and combinations thereof.

27. The system of claim 19, wherein:
the host communications device is associated with a church; and
the host information is selected from the group consisting of: digital information, audio files, videos, presentations, sheet music, lyrics, written sermons, donation requests, a donation collection widget, prayer chains, announcements, links to external websites, and combinations thereof.

28. The system of claim 19, wherein:
the host communications device is associated with an advertiser; and
the host information is selected from the group consisting of: digital information, coupons, incentives, polls, a hub capable of collecting and displaying audience photographs, a hub capable of collecting and displaying audience videos, polls, questions, a hub capable of collecting and displaying audience messages, games, trivia, contests, announcements, links to social media, embedded social media widgets, and combinations thereof.

29. The system of claim 19, wherein:
the host communications device is associated with a meeting organizer; and
the host information is selected from the group consisting of: digital information, presentations, assignments, business materials, club materials, educational materials, notes, handouts, audio files, videos, announcements, agendas, updates, lists, a hub capable of collecting and displaying audience photographs, a hub capable of collecting and displaying audience videos, a hub capable of collecting and displaying audience messages, questions, polls, scheduling widgets, a hub for digitally collaborating with other audience members, fields for answering questions posed live, and combinations thereof.

30. The system of claim 19, wherein:
the host communications device is associated with a community organizer; and
the host information is selected from the group consisting of: digital information, registration forms, fliers, notes, handouts, audio files, videos, announcements, updates, descriptive information about a camp, descriptive information about an event, descriptive information about a cause, descriptive information about a protest, polls, schedules, weather information, parking information, answers to frequently asked questions, advertisements, a hub capable of collecting and displaying audience photographs, donation requests, a donation collection widget, a hub capable of collecting and displaying audience videos, a hub capable of collecting and displaying audience messages, links to social media, embedded social media widgets, questions, polls, and combinations thereof.

31. The system of claim 19, wherein:
the host communications device is associated with a sports organization; and
the host information is selected from the group consisting of: digital information, handouts, registration forms, audio files, videos, schedules, driving directions, tournament information, parking information, announcements, answers to frequently asked questions, advertisements, incentives, score updates, schedule changes, parking updates, links to social media, embedded social media widgets, play-by-play updates, standings, real-time statistics, real-time descriptive information corresponding to real-time game happenings, streaming audio, tickets on sale, a payment collection widget, a hub capable of collecting and displaying audience photographs, a hub capable of collecting and displaying audience videos, a hub capable of collecting and displaying audience messages, games, trivia questions, real-time coordinated content, real-time countdown timers, and combinations thereof.

32. The system of claim 19, wherein:
the host communications device is associated with a retail store; and
the host information is selected from the group consisting of: digital information, fliers, coupons, incentives, audio files, videos, item availability information, menu information, a reservation system to order merchandise, a reservation system to hold a table, a reservation system to order items for delivery, updates, announcements, advertisements, promotional information, real-time wait time information, real-time checkout line information, a system providing frequent user rewards, a payment collection widget, links to social media, embedded social media widgets, and combinations thereof.

33. The system of claim 19, wherein:
the host communications device is associated with a teacher; and
the host information is selected from the group consisting of: digital information, documents, notes, handouts, pictures, sound clips, videos, registration forms, questions that the teacher wants answered over an extended period of time, questions that the teacher wants answered in real time, polls, digital versions of classroom notes, digital versions of lectures, digital versions of presentations, links to websites that are external to the information sharing service, assignments, and combinations thereof.

34. The system of claim 19, wherein the processor is further configured to obtain the host information from the host communications device and to provide the host information to the audience member communications device in real-time.
